(19) United States
(12) Patent Application Publication
(10) Pub. No.: US 2014/0236594 A1
(43) Pub. Date: Aug. 21, 2014

(54) ASSISTIVE DEVICE FOR CONVERTING AN AUDIO SIGNAL INTO A VISUAL REPRESENTATION

(71) Applicant: Rahul Govind Kanegaonkar, Orpington, Kent (GB)

(72) Inventors: Roger Clarke, Royston (GB); Antony William Rix, Royston (GB)

(73) Assignee: Rahul Govind Kanegaonkar, Orpington, Kent (GB)

(21) Appl. No.: 14/348,221

(22) PCT Filed: Oct. 2, 2012
(86) PCT No.: PCT/GB2012/052432

§ 371 Date: Mar. 28, 2014

(30) Foreign Application Priority Data
Oct. 3, 2011 (GB) 1116994.3

(51) Int. Cl. G10L 21/10; H04R 25/00; G02B 27/01; G10L 15/26

(52) U.S. Cl. CPC G10L 21/10; G10L 15/26; H04R 25/554; G02B 27/017; G10L 2021/065
USPC 704/233; 704/235

(57) ABSTRACT

A device for converting an audio signal into a visual representation, the device comprising at least one receiver for receiving the audio signal; a signal processing unit for processing the received audio signal; a converter for converting the processed audio signal into a visual representation; and projecting means for projecting the visual representation onto a display, wherein the display comprises an embedded grating structure.

This invention generally relates to an assistive device to help users with a hearing impairment.

Wearable or so called ‘head-up’ displays for vehicle or military applications for are known. A common disadvantage of such known devices is that they are bulky and/or obscure the field of view of a user. For example, the 2009 Toyota Prius projects a display onto a car windscreen that can be configured to show vehicle speed, throttle or navigation information. A reflective element with a flat or continuously curved surface is required, taking up space and making it difficult to create a small, unobtrusive device. Another example is represented by the MicroOptical Corporation's MyVu products, built as video glasses that embed a display and associated optics into a head-worn device. Such devices are typically designed for personal movie viewing and have the disadvantage of obscuring at least part of the field of view as well as appearing large and obtrusive.

To overcome the disadvantages of known wearable or ‘head-up’ displays, head or spectacles-mounted, see-through (i.e. non-obscuring) display devices have been proposed. Wearable displays with this characteristic have been described for cinema captioning to assist people with a hearing impairment. Cinema captioning systems typically receive a feed of subtitle text from the movie being shown that is synchronised to the words spoken on the movie soundtrack. For example, a short film by the BBC available at http://www.bbc.co.uk/news/technology-14654339 (25 Aug. 2011) demonstrates an apparently holographic, wearable display developed by Sony Corporation showing cinema subtitles, allowing a hearing impaired customer to enjoy a subtitled movie without needing to display subtitles on or near to the cinema screen.

Certain primarily military applications use a holographic approach for a head-up display, where a laser is used to project a display image onto a holographic optical element arranged to act like an angled mirror at the laser's particular wavelength. A disadvantage of these devices for wearable applications is that a laser is required, with size, safety and power issues; further, the hologram can produce unwanted colouring or filtering at other wavelengths. The display shown in the Sony Corporation example noted above would appear to suffer from these characteristics.

A different type of hearing aid relating to spectacles is also known. By including multiple microphones into the frame of the spectacles, and performing array signal processing as described for example in Haykin, Array Signal Processing, Prentice Hall, 1985, sound from in front of the wearer may favourably be detected and noises from the sides or behind may be suppressed. Merks's Ph.D. thesis, Binaural Application of Microphone Arrays for Improved Speech Intelligibility in a Noisy Environment, TU Delft (NL), 2000 describes an arrangement of a wearable microphone feeding earpieces, all integrated into a spectacles frame, providing an acoustic hearing aid with improved directionality. This helps a hearing impaired person understand sound, in particular in noisy or reverberant environments. Such a device is, however, only suited to users able to wear an acoustic hearing aid.

A related spectacles mounted microphone array is available for users who may not be able to wear an acoustic hearing aid but who still retain conductive hearing. The BHM Tech Evo-1 is similar to the Merks device except that it uses bone conduction of sound through the arms of the spectacles rather than through earpieces. Again, this is only suitable for certain types of hearing loss.

The concept of using automatic speech recognition to help deaf people understand the spoken word is well established. It is discussed, for example, in Waibel & Lee, Readings in Speech Recognition, Morgan Kaufmann Publishers, 1990, p. 1, which also mentions a related concept that the transcription output by a speech recogniser could be passed to a machine translation system, allowing the user to understand speech in another language. Speech recognisers are commercially available in many languages. However, at present, speech recognisers do not perform well in the distant talker context required by assistive devices.

Several attempts have been made to develop generic speech recognisers into assistive devices for the hearing impaired. U.S. Pat. No. 6,005,536 (Captioning Institute) and US20020158816 (HP Labs) describe using a wearable display attached to spectacles, in conjunction with a microphone array, speech recognition and optionally machine translation. In particular, U.S. Pat. No. 6,005,536 describes a head-mounted apparatus for downward projection of a display of subtitles relating to the presentation or performance being viewed, which may be derived from a speech recogniser and/or machine translation device. The system includes a projective display illuminating a partial reflector placed at 45 degrees in front of the eye, allowing the user to see a reflection of the projected display superimposed on the image behind. This is a principle used in aviation and vehicle displays and has the disadvantage that an obtrusive, reflective element with a flat or continuously curved surface is required.

US 20020158816 further develops the concept with a microphone array and portable processor and describes two types of display units. One type (130 in US 20020158816) projects an image from a small LCD display into a prism optic placed just in front of the eye, with lenses to ensure that the image is formed at a comfortable viewing distance. This produces a device that is somewhat obtrusive and that partially obscures the wearer's view. The other type (108 in US 20020158816) directly projects a display into an optical element incorporated inside the spectacle lens, requiring the projection apparatus to be coupled to the side of the spectacle lens. Again, this produces a device that is physically large and obtrusive; further, it limits how the spectacle lens may be configured, for example making it difficult to provide a prescription lens.

Another type of see-through display has been developed by Lumus Vision. This uses a light guiding approach to transmit a picture through the side of an optical element held in front of the eye. This leads to a bulky device as the imaging element must be located next to, and optically coupled into, the lens.

The present invention has been developed to overcome the problems associated with the prior art and provide an unobtrusive assistive device with real type speech recognition capability.

According to the present invention, there is provided a device for converting an audio signal into a visual representation, the device comprising:

at least one receiver for receiving the audio signal;

a signal processing unit for processing the received audio signal;

a converter for converting the processed audio signal into a visual representation; and

projecting means for projecting the visual representation onto a display, wherein the display comprises an embedded grating structure.

Key to the invention is that it provides an unobtrusive means for the wearer to see a transcription of a nearby conversation. In a preferred embodiment, a pair of spectacles to be worn by the user is fitted with (a) microphones to capture the sound, (b) a link to apparatus performing speech recognition on the captured sound, and (c) a display integrated into the spectacles that presents the transcribed speech output by the recogniser. By wearing the device, persons who would otherwise be unable to hear are instead able to read what is being said to them. For the deaf or those with profound hearing impairments that cannot be addressed by means of conventional acoustic aids, this could allow something approaching normal conversation.

The assistive device contemplated in the present invention can be summarised as follows.

The device displays speech from a talker conversing with the wearer, captured using microphones that may optionally be integrated into the device, and using speech recognition. It may thus be used by people who cannot use acoustic or bone conducted hearing aids or in applications where the ears should not be used. The device is wearable so that it may be used in a number of scenarios in daily life.

The assistive device according to the present invention represents a personal, and wearable subtitling apparatus that could, for example, be used in the cinema and in other locations, reacting in real time to the sound received, albeit presenting the transcription with a processing delay.

Importantly, the device and its display are unobtrusive, preferably integrated into spectacles that appear to other people to be completely normal, thereby avoiding any stigma associated with hearing impairment. The spectacles preferably can be adjustable to the wearer's optical prescription, as many users will also need vision correction. The device integrates a microphone or microphones, using signal processing techniques such as directional array processing, noise reduction and voice detection, to maximise the performance of the speech recognition.

Furthermore, the present invention improves upon US 20020158816 and U.S. Pat. No. 6,005,536 in particular in the following aspects.

A novel embedded grating illuminated by a projector is used to provide an unobtrusive wearable display that presents the output of the speech recogniser. The embedded grating is a frequency-selective optical element that is incorporated inside or affixed to the surface of the spectacle lens, while the projector is placed alongside the wearer's temple or incorporated into the arms of the spectacle. This avoids the disadvantages associated with the display units described in US 20020158816 and U.S. Pat. No. 6,005,536.

Preferably, the embedded grating structure is embedded between at least two media of substantially the same optical refractive index, the structure having an optical coating at the interface between two media, wherein the structure comprises grating facets inclined relative to the interface plane. The shape of the grating may be such that anomalous optical effects due to the coating at the grating edges are substantially reduced.

Preferably, improved signal processing is applied to microphone signals to optimise the performance of the speech recogniser.

Preferably, improved speech recognition is performed by allowing the device to be configured for specific talkers and by discriminating between the speech of the wearer and desired talker.

Preferably, the speech recognition is trained using speech captured with the device, including its signal processing, and transcribed or corrected by humans.

The embedded grating may be the device described in patent application PCT/GB2011/000551, which is hereby incorporated by reference. The use of an embedded grating is particularly advantageous compared to the prior art because the embedded grating:
is see-through, allowing the wearer a clear view of the environment and talker, for example permitting the wearer also to lip-read;
can be integrated unobtrusively into spectacles lenses
can be incorporated into lenses to be machined to the user's ophthalmic prescription using conventional optician processes, or the embedded grating can be fitted as an additional layer to existing prescription lenses;
can be used with miniature, low-cost projectors allowing the overall product to be small and light;
does not require a laser to form the image, so avoiding the power, safety and image quality issues associated with laser projection;
can be coated to reflect at several optical wavelengths, allowing more than one colour to be used in the display;
is almost invisible when incorporated into a spectacle lens;
reflects the vast majority of the projected light, preventing other people from seeing the transcribed speech and making a covert display possible.

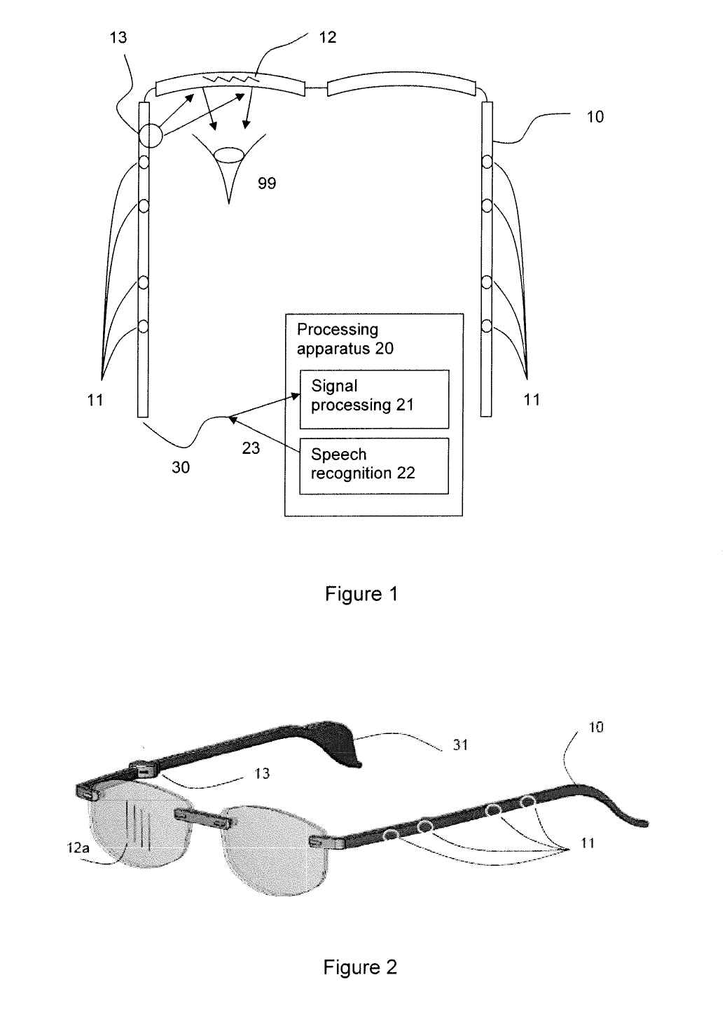

FIG. 1 represents an assistive device in accordance with the present invention;

FIG. 2 is another representation of an assistive device in accordance with the present invention;

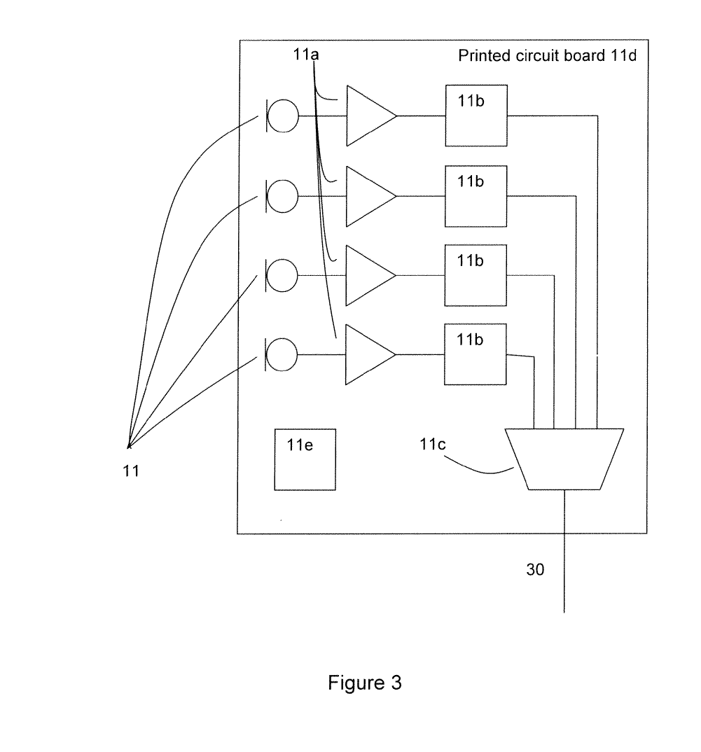

FIG. 3 shows how microphone signals are passed to the processing apparatus;

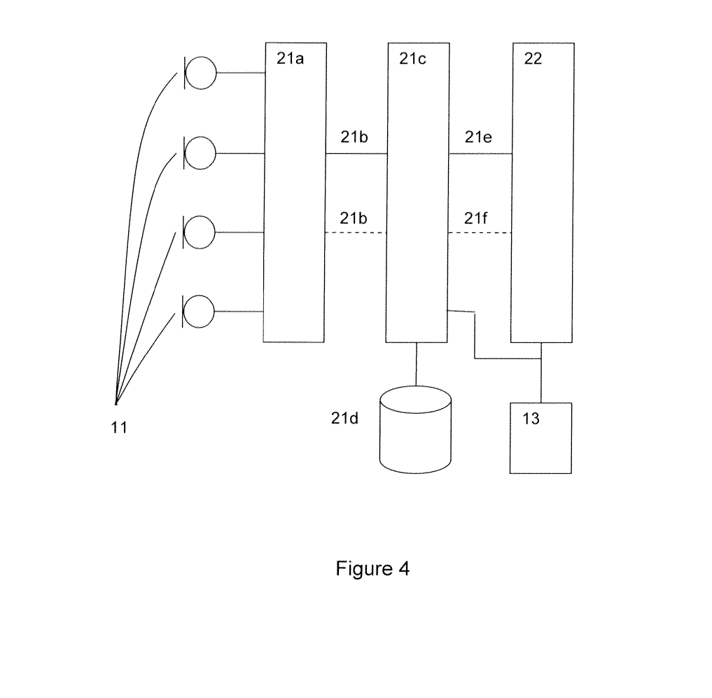

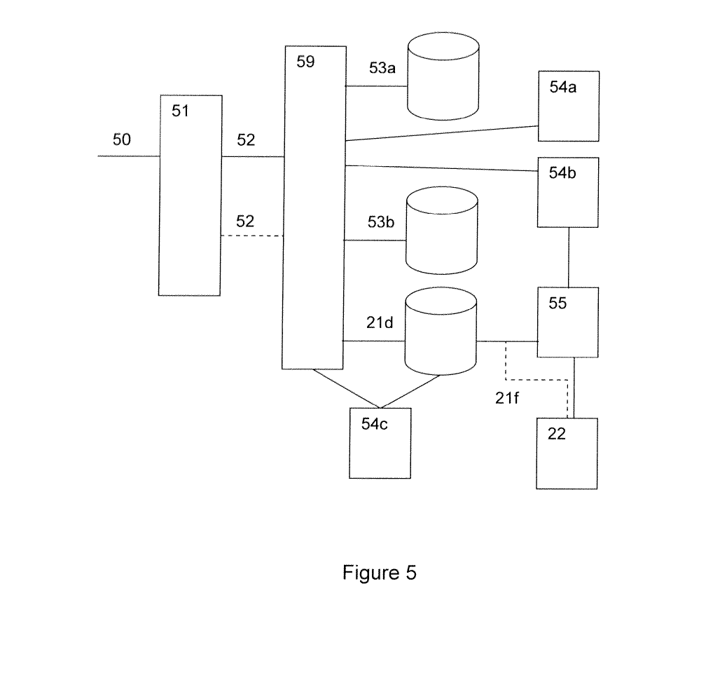

FIG. 4 shows in more detail the signal processing aspect of the invention;

FIG. 5 shows how signal classification and noise reduction may be arranged as part of the signal processing aspect of the invention; and

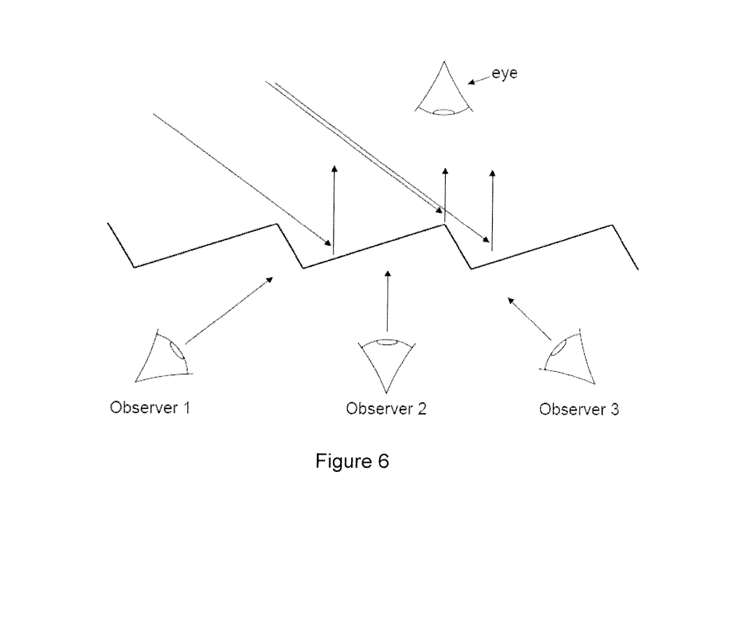

FIG. 6 is a detailed view of an embedded grating used in an assistive device according to the present invention.

An embodiment of the present invention will now be described with reference to the figures.

FIG. 1 provides an example configuration of the present invention where the microphones 11, embedded grating 12 and projector 13 are integrated into a pair of spectacles 10. The microphone signals are passed by a communications link 30 to a processing apparatus 20. The processing apparatus performs signal processing 21 and speech recognition 22, outputting a continuous transcription 23 that is sent over the communications link 30 to the projector 13. The projector 13 forms an image via the embedded grating 12 that is visible by the wearer's eye 99.

The device could equally be configured with the display illuminating the left or right eye, or both eyes, by appropriately locating one or two projectors and one or two embedded gratings which will be described in more detailed below. The processing apparatus may be a mobile phone or other computing device and/or may be a microprocessor or digital signal processor embedded within the device as known in the art.

A microphone 11 could be remotely located, for example worn by the talker and communicating over a wired or wireless link with the device. By placing the microphone closer to the talker, the desired talker's voice is preferentially amplified compared to noise or other speakers.

FIG. 2 illustrates the product concept of FIG. 1, showing in particular the way that the microphones 11, embedded grating 12 and projector 13 are integrated into a pair of spectacles 10, along with a wireless communications link 31.

FIG. 3 shows in more detail how the microphone signals are passed to the processing apparatus, in an arrangement where the microphones are placed in the arms of the spectacles 10. Components from one arm are shown. Each microphone 11 is amplified 11a and sampled by an analogue to digital converter 11b. The sampled signals are sent by multiplexer and communications device 11c to the processing apparatus 20 over the communications link 30. Printed circuit board 11d mounts and connects components 11, 11a, 11b, 11c and optionally provides power from a battery 11e.

In a wired arrangement of FIG. 3, the link between the processing apparatus and the microphone may use a serial digital protocol such as I2S and the amplifiers 11a, analogue to digital converters 11b and multiplexer 11c would be integrated into an audio codec chip that is controlled by the processing apparatus 20. In this arrangement, power would preferably be provided through the cable that forms the communications link 30 between the spectacles 10 and processing apparatus 20.

In a wireless arrangement of FIG. 3, the communications link would be a wireless link such as Bluetooth. The multiplexer and communications device 11c may also in this arrangement perform aspects of the signal processing such as array combining, feature extraction and/or audio compression, to reduce the data rate and power consumption required for the wireless link.

FIG. 4 shows in more detail the signal processing aspect of the invention. The sampled signals from the microphones 11 are passed to an array processor 21a such as a delay-and-sum beamformer or the process described by Merks that forms at least one array signal 21b. The array processor 21a may advantageously be configured to adapt at least one of its array patterns to attenuate sounds such as background noise or other talkers that do not come from in front of the wearer. Noise is undesirable as it can reduce a speech recogniser's accuracy. A classification and noise modelling process 21c performs voice activity detection and optionally noise reduction on each array signal 21b. A noise model 21d is calculated comprising at least one parameter indicative of the level of noise signal. When the desired talker is detected, this may be signalled on the projector 13, and at least one processed array signal 21e is passed to a speech recognition process 22. If the noise modelling process is not arranged to perform full noise reduction, at least one noise model 21f may also be passed to the speech recognition process 22. The transcription output is sent to the projector 13.

As is known, a microphone may be designed to selectively filter sounds depending on the direction of arrival (a directional microphone), or to reproduce sounds with little or no such filtering (an omnidirectional microphone). An array of microphones, whether directional or omnidirectional or a combination of the two, can be arranged with appropriate array processing to have a directional characteristic. Different types of microphones perform in different ways. For example, an omnidirectional microphone may have higher gain and lower internal noise than a directional microphone of similar size and power consumption. If the wanted signal (for example a person speaking) is not in the axis of a directional microphone, it would be undesirably filtered, so such off-axis signals are preferentially detected using one or more omnidirectional microphones. In the presence of some types of environmental noise, a directional microphone may provide greater beneficial noise reduction. According to the invention, with reference to FIG. 4, the microphones 11 may optionally include at least one directional microphone and at least one omnidirectional microphone. Depending upon the characteristics of the noise 21d or the signals 21b, the array processor 21a may select, filter, delay and/or amplify the signals from the microphones 11 differently to give greater or lesser weight to each type of microphone, thereby preferentially selecting the wanted signal from noise.

Directional processing is not always able to eliminate noise and it may therefore be of benefit, according to the invention, to model and reduce noise using known noise reduction methods. The methods used for the classification and noise modelling process 21c can be similar to those used in mobile telephones. An improvement to known voice activity detection and noise reduction schemes for this invention is the extension of the classification process to distinguish at least three sources of sound. This is illustrated in FIG. 5, which provides more detail on how the classification and noise modelling process 21c may be arranged.

A sound signal 50 (which may be an array signal 21b) is received by a feature extraction process 51. At least one acoustic feature 52, such as signal level, standard deviation, pitch or voiced/unvoiced indicator, or at least one combination of such features, is derived indicative of the contents of the signal during at least one time interval. In a decision process 59, when at least one acoustic feature 52 matches or exceeds at least one stored value 53a indicative of the wearer's voice, for example if very loud signals with speech-like characteristics are detected, the signal at that time interval is classified as the wearer speaking 54a, and in this case noise modelling updates are disabled and the signal may optionally not be passed to the speech recogniser 22. When at least one acoustic feature 52 matches or exceeds at least one stored value 53b indicative of the talker's voice, and/or if the at least one acoustic feature is not indicative of (i.e. does not match) the noise model 21d, for example when intermediate loudness signals with speech-like characteristics are detected, the signal at that time interval is classified as the desired talker speaking 54b, and noise modelling updates are disabled but the signal may optionally be processed by a noise reduction process 55 and is then passed to the speech recogniser 22, optionally accompanied by the current noise model 21f. When neither the wearer nor talker are detected, time interval is classified as noise 54c, the noise model 21d is updated and the signal may optionally not be passed to the speech recogniser 22. In this way, the speech recogniser is able to process the desired signal taking into account the environmental noise, and is not passed the wearer's speech allowing the recogniser to optimise for the characteristics of the other talker, not the wearer. This has the benefit of improving speech recognition accuracy.

Experiments conducted by the inventors have indicated that conventional speech recognisers may benefit from improvement for use in an assistive device for the hearing impaired, to further improve speech recognition accuracy in contrast to the prior art.

A speaker identification means may be provided, either using a human interface with the wearer or an automatic speaker identification process. This may be used to select a speech recognition model and/or stored parameters indicative of the present talker, talker's gender, age, pronunciation, dialect or language, for use by the speech recognition process 22 to allow its performance to be maximised for each talker.

A networked speech recognition means may be provided, where at least one part of the speech recognition process 22 is performed on at least one remote computation device that communicates with the assistive device over a network such as a mobile phone network. By permitting computationally, power or data intensive tasks to be performed using shared hardware with a separate power source, recognition accuracy may be improved and the size or power consumption of the processing apparatus 20 may be reduced.

The methods of training the speech recogniser 22 and/or the speaker identification means are also important. Preferably, the assistive device or the networked part of the speech recognition process may be arranged to selectively record speech signals. For example, during product development, trials, a training period or when a user first uses a device, all signals may be recorded, while in normal use, recordings would not be made or only made where the speech recogniser's confidence estimates are low or if this is requested in a user interface. Recordings could be processed through a manual or separate automatic training process that calculates optimised parameters for use by the speech recogniser 22. Such parameters would then be transferred to a processing apparatus, networked recogniser or assistive device to improve its recognition accuracy.

FIG. 6 represents an embedded grating 12 structure with inclined grating facets relative to an interface plane between the grating and the lens. The structure is preferably embedded between media of substantially same optical refractive index (i.e. the spectacles lens), having an optical coating at the interface between the two media. The coating on the surface of the embedded grating 12 does not cause substantial visible optical effects to the casual observer. Furthermore, the embedded grating 12 is shaped to correct for astigmatism of light passing through the back surface of a spectacle lens, therefore providing further optical functionality (such as image magnification or focussing) in combination with the projection optics.

Observers 1 and 2 in FIG. 6 are expected to see the embedded grating 12 with no anomalous behaviour, whereas Observer 3 is expected to see some anomalous behaviour from the return surface, but only from a small range of angles to one side of the spectacle wearer. For most casual viewing directions from an observer towards a person wearing the spectacles, the embedded grating is substantially invisible.

Employing individual tilt angles and surface profiles may be used to provide focus, magnification, astigmatism compensation, or other optical aberration compensation for use in combination with other optics in the system.

The non-vertical walls may be curved to substantially reduce the apparent optical anomalous behaviour of an optical coating on a grating surface. The anomalous behaviour may be reduced by promoting more equal coating properties or moving the angle of the observable effect to an angle where it is unlikely to be conspicuous to the casual observer.

The optical coating is designed to reflect specific bands or multiple bands of visible or near-visible light, and/or the image source is passed through a colour filter such that the user sees nearly 100% of the reflected light at the appropriate wavelengths, and the transmission of these wavelengths is near zero so that an observer is not generally aware of them. The bands of reflected light may be towards the red or the blue end of the spectrum such that the optical device looks substantially colourless, or there may be multiple bands of light such that the optical device looks substantially colourless but with a reduced average transmission.

The same angles can be used in both parts of the grating (active surface and return surface) to produce a symmetrical grating structure. If the grating is near the pupil plane of the imaging system and the angles are such that light from the return surface are directed away from the eye, than the main reduction in performance will be the amplitude of the image observed in reflectance. Therefore, by making the active and return angles more similar the optical performance of the coating becomes similar and the embedded grating becomes more difficult to observe.

By making the return angle of the grating smaller than the nominal grating angle one can further reduce the visibility of the grating by effectively reducing the surface area of the grating and thus its visibility.

1. A device for converting an audio signal into a visual representation, the device comprising:
at least one receiver for receiving the audio signal;
a signal processing unit for processing the received audio signal;
a converter for converting the processed audio signal into a visual representation; and
projecting means for projecting the visual representation onto a display, wherein the display comprises an embedded grating structure.

2. A device according to claim 1, wherein the embedded grating structure is embedded between at least two media of substantially the same optical refractive index, the structure having an optical coating at the interface between two media, wherein the structure comprises grating facets inclined relative to the interface plane.

3. A device according to claim 2, wherein the facets of the embedded grating structure are substantially curved.

4. A device according to claim 2, wherein the shape of the grating is such that anomalous optical effects due to the coating at the grating edges are substantially reduced

5. A device according to claim 1, wherein the optical coating is arranged to substantially reflect light of at least one visible frequency and to substantially transmit light within at least one range of other visible frequencies.

6. A device according to claim 1, wherein the received audio signal is transmitted wirelessly to the signal processing unit.

7. A device according to claim 1, wherein the converter comprises speech recognition means.

8. A device according to claim 7, wherein the speech recognition means communicates wirelessly with at least one server configured to performs at least part of the converting.

9. A device according to claim 7, wherein the speech recognition means is adaptable to characteristics indicative of a talker generating the audio signal.

10. A device according to claim 7, wherein the speech recognition means is adaptable according to signals recorded by the device that have been annotated or corrected by a human.

11. A device according to claim 7, wherein the speech recognition means discriminates between noise, speech from a talker, and speech from a user, and wherein the device varies either or both the display or the signal passed to the speech recognition means according to this classification.

12. A device according to claim 1, further comprising recording means for recording the received audio signal.

13. A device according to claim 1, wherein processing the received audio signal by the processing unit comprises at least one of:
means for identifying signal noise;
means for noise reduction; and
means for adapting the processing of a speech recogniser dependent upon at least one indicator relating to noise.

14. A device according to claim 1, wherein the at least one receiver comprises an omnidirectional microphone and at least one directional microphone.

15. Spectacles comprising a device according to claim 1, wherein an embedded grating structure is embedded within a lens.

16. Spectacles comprising a device according to claim 1, wherein at least one projector is attached to or integrated into an arm of the spectacles.

17. Spectacles according to claim 15, wherein the at least one receiver is integrated into or attached to a spectacle frame.

18. Spectacles according to claim 15, the spectacles further comprising at least one of:
an earpiece for playing an audio signal;
a bone transducer; and
a wireless communication means for relaying a sound signal into a conventional hearing device.
